(19) United States
(12) Patent Application Publication
(10) Pub. No.: US 2024/0418888 A1
(43) Pub. Date: Dec. 19, 2024

(54) FORECASTING CO2 PLUME BODIES IN SEQUESTRATION OPERATIONS

(71) Applicant: Schlumberger Technology Corporation, Sugar Land, TX (US)

(72) Inventors: Zhun Li, Houston, TX (US); Wenyi Hu, Houston, TX (US); Aria Abubakar, Sugar Land, TX (US)

(21) Appl. No.: 18/702,701

(22) PCT Filed: Nov. 9, 2022
(86) PCT No.: PCT/US2022/049421

§ 371 Date: Apr. 18, 2024

Related U.S. Application Data
(60) Provisional application No. 63/263,785, filed on Nov. 9, 2021.

(51) Int. Cl. G01V 1/30; E21B 41/00

(52) U.S. Cl. CPC G01V 1/303; E21B 41/0064; E21B 2200/22

(57) ABSTRACT

A method includes receiving input including baseline data representing a subsurface volume prior to an injection operation, injection data representing an injection operation during a first timestep, and an initial pressure and saturation data at the beginning of the first timestep, training a machine learning model to predict a first pressure and saturation map at an end of the first timestep based on baseline data, the injection data, and the initial pressure and saturation data, and training the machine learning model to predict a second pressure and saturation model at an end of a second timestep based on the baseline data, injection data representing the injection operation during the second timestep, and the first pressure and saturation map at the end of the first timestep. The trained machine learning model is configured to predict an implementation pressure and saturation map at a plurality of times during an injection operation.

### CROSS-REFERENCE TO RELATED APPLICATIONS

This application claims priority to U.S. Provisional Patent Application having Ser. No. 63/263,785, which was filed on Nov. 9, 2021 and is incorporated herein by reference in its entirety.

### BACKGROUND

Carbon dioxide (CO2) sequestration may involve injecting CO2 into subsurface volumes. Such injection creates a CO2 plume, which refers to the three-dimensional location of the free-phase and dissolved CO2 in the volume. Forecasting plume body of a CO2 sequestration field facilitates managing injection operations. This forecasting can, for example, be used in decision-making for effective field development and process monitoring.

In general, the CO2 plume is located using time lapse data. Generally, signals such as seismic, electromagnetic, and/or others are directed through the subsurface volume to identify the current location of the CO2 plume boundary. For example, signals that propagate through CO2 plums may be identified and distinguished from those that have not, e.g., based on different signal characteristics caused by the different propagation mediums.

However, such time lapse detection does not provide a future forecast of how the plume body evolves in the future under different injection scenarios. A full-scale reservoir simulator can undertake such forecasting processes. Such models are highly complex, however, and may consume large amounts of processing resources and time.

### SUMMARY

Embodiments of the disclosure include a method including receiving input including baseline data representing a subsurface volume prior to an injection operation, injection data representing an injection operation during a first timestep, and an initial pressure and saturation data at the beginning of the first timestep, training a machine learning model to predict a first pressure and saturation map at an end of the first timestep based at least in part on baseline data, the injection data, and the initial pressure and saturation data, and training the machine learning model to predict a second pressure and saturation model at an end of a second timestep based at least in part on the baseline data, injection data representing the injection operation during the second timestep, and the first pressure and saturation map at the end of the first timestep. The machine learning model is trained to predict an implementation pressure and saturation map at a plurality of times during an injection operation.

Embodiments of the disclosure include a computing system having one or more processors, and a memory system including one or more non-transitory, computer-readable media storing instructions that, when executed by at least one of the one or more processors, cause the computing system to perform operations. The operations include receiving input including baseline data representing a subsurface volume prior to an injection operation, injection data representing an injection operation during a first timestep, and an initial pressure and saturation data at the beginning of the first timestep, training a machine learning model to predict a first pressure and saturation map at an end of the first timestep based at least in part on baseline data, the injection data, and the initial pressure and saturation data, and training the machine learning model to predict a second pressure and saturation model at an end of a second timestep based at least in part on the baseline data, injection data representing the injection operation during the second timestep, and the first pressure and saturation map at the end of the first timestep. The machine learning model is trained to predict an implementation pressure and saturation map at a plurality of times during an injection operation.

Embodiments of the disclosure include a non-transitory, computer-readable medium storing instructions that, when executed by at least one processor of a computing system, cause the computing system to perform operations. The operations include receiving input including baseline data representing a subsurface volume prior to an injection operation, injection data representing an injection operation during a first timestep, and an initial pressure and saturation data at the beginning of the first timestep, training a machine learning model to predict a first pressure and saturation map at an end of the first timestep based at least in part on baseline data, the injection data, and the initial pressure and saturation data, and training the machine learning model to predict a second pressure and saturation model at an end of a second timestep based at least in part on the baseline data, injection data representing the injection operation during the second timestep, and the first pressure and saturation map at the end of the first timestep. The machine learning model is trained to predict an implementation pressure and saturation map at a plurality of times during an injection operation.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a schematic view of a basic unit of a CO2 reservoir proxy model in a recurrent network model, according to an embodiment.

FIG. 5 illustrates a flowchart of a method for training a model to predict a feature of a subsurface volume, e.g., a plume body location, using an interpreter-derived plume body as a ground-truth label, according to an embodiment.

FIG. 6 illustrates a schematic view of the model executing the method of FIG. 5 for multiple timesteps, according to an embodiment.

FIG. 7 illustrates a flowchart of another method for predicting a plume body, according to an embodiment.

FIG. 8 illustrates a schematic view of training the neural network proxy model using a monitoring seismic and/or velocity model, according to an embodiment.

FIG. 9 illustrates a schematic view of the machine learning model being used to predict a feature of a subterranean volume, e.g., forecasting the plume body, once the model has been trained, according to an embodiment.

FIG. 10 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention.

However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

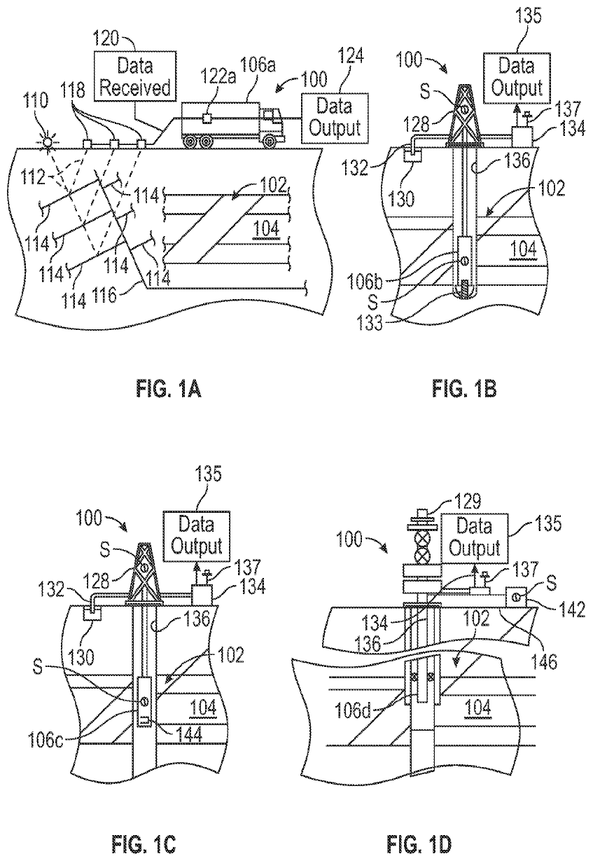

FIGS. 1A-1D illustrate simplified, schematic views of oilfield 100 having subsurface formation 102 containing reservoir 104 therein in accordance with implementations of various technologies and techniques described herein. FIG. 1A illustrates a survey operation being performed by a survey tool, such as seismic truck 106.1, to measure properties of the subsurface formation. The survey operation is a seismic survey operation for producing sound vibrations. In

FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subsurface formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subsurface formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors(S), such as gauges, may be positioned about oilfield 100 to collect data relating to various oilfield operations as described previously. As shown, sensor(S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors(S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by surface unit 134 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subsurface formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subsurface formation 102.

Sensors(S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors(S), such as gauges, may be positioned about oilfield 100 to collect data relating to various field operations as described previously. As shown, the sensor(S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subsurface facilities. Also, while certain data acquisition tools are depicted, it will be appreciated that various measurement tools capable of sensing parameters, such as seismic two-way travel time, density, resistivity, production rate, etc., of the subsurface formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

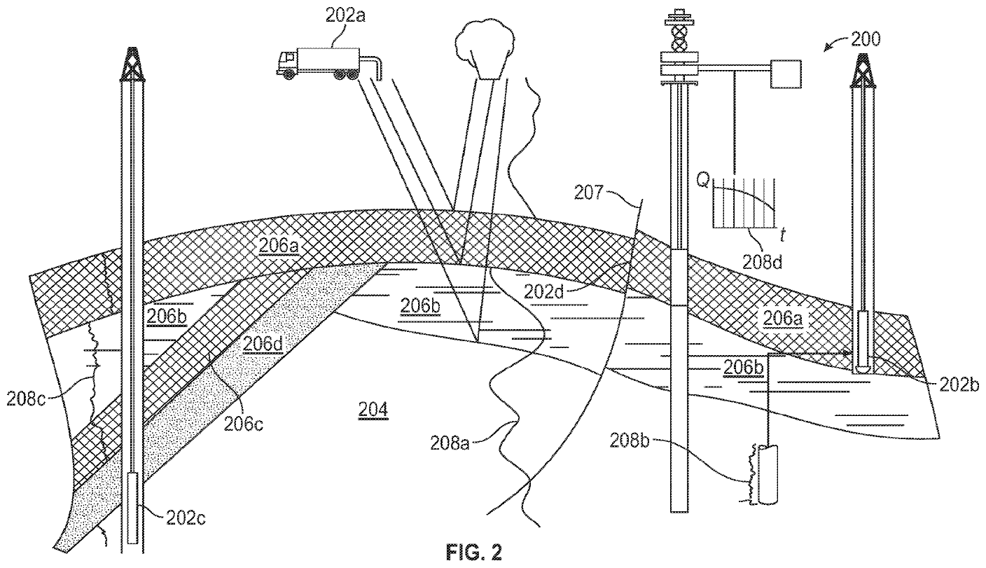

FIG. 2 illustrates a schematic view, partially in cross section of oilfield 200 having data acquisition tools 202.1, 202.2, 202.3 and 202.4 positioned at various locations along oilfield 200 for collecting data of subsurface formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subsurface formation to determine characteristics thereof. Similar measurements may also be used to measure changes in formation aspects over time.

The subsurface structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subsurface formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subsurface formations and features. The core data shown in static plot 208.2 and/or log data from well log 208.3 are typically used by a geologist to determine various characteristics of the subsurface formation. The production data from graph 208.4 is typically used by the reservoir engineer to determine fluid flow reservoir characteristics. The data analyzed by the geologist, geophysicist and the reservoir engineer may be analyzed using modeling techniques.

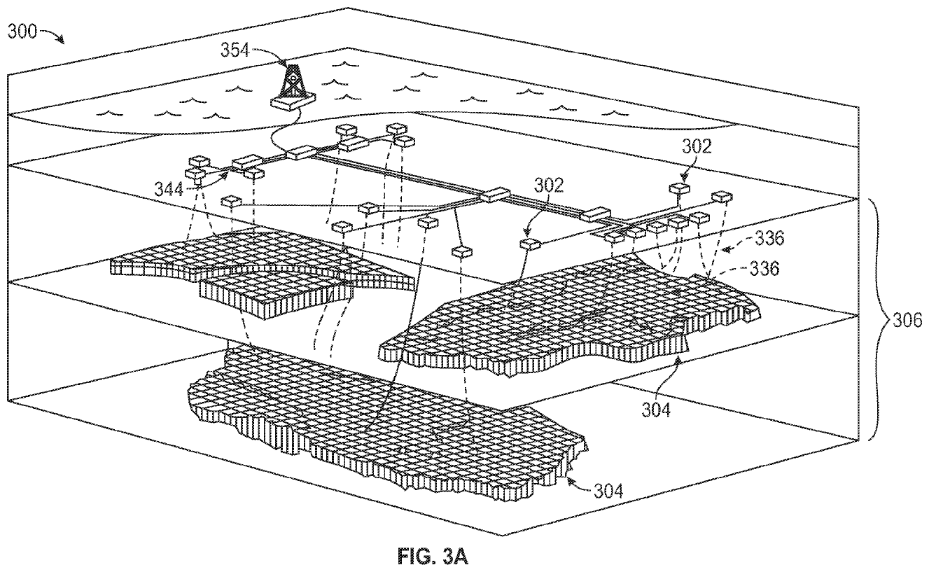

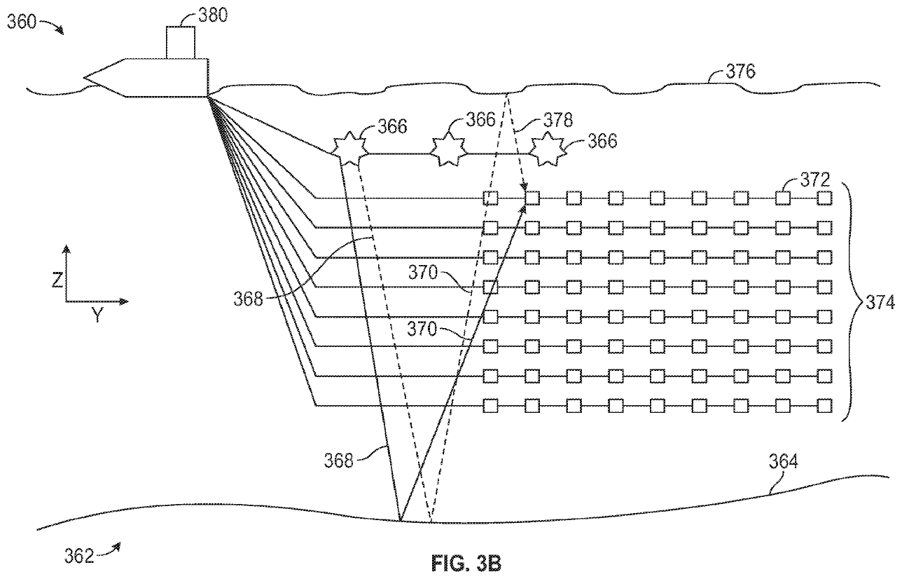

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subsurface formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subsurface subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

Embodiments of the present disclosure implement a machine learning (e.g., neural network) based reservoir “proxy” model to forecast a CO2 plume body, specifically, a map that identifies the CO2 pressure and saturation at different times. This data-driven model is configured to predict the output of a full-scale reservoir simulation, without running such a complex and computation-intensive model. This network architecture may, in some embodiments, include a recurrent neural network serving as a reservoir proxy model and a convolutional neural network serving as an encoder to extract information from the seismic image in both training and predicting phases, as will be described in greater detail below. Time-lapse seismic data may provide both input and ground truth labels for the network.

The CO2 injection field may be in operation for a certain period of time (e.g., one or more years). During this time, baseline seismic (and/or other types of) data may be obtained before the CO2 injection. Monitoring seismic data may also be acquired after the CO2 injection is initiated. Historical seismic “snapshots”, based on this baseline and monitoring data may be utilized for history matching in the construction of the proxy model; that is, control variables (neural network connection weights) of the proxy model can be determined and/or modified based on the predictions made by the proxy model, and the historical observations. Differences between the predictions and the observations can then be minimized by adjusting the control variables of the proxy model.

The history-matched proxy model can perform the forecast with different injection scenarios. In the terminology of neural network, history matching part may be implemented during the network training phase. Forecasting may be implemented in the network prediction phase. It will be appreciated that embodiments of the present disclosure may also be suitable for use with other types of data, such as electromagnetic signal data. Further, the other type of signals may be combined with seismic (or with any other signal) and considered simultaneously or may be considered independently.

### Basic Unit of Reservoir Proxy Model

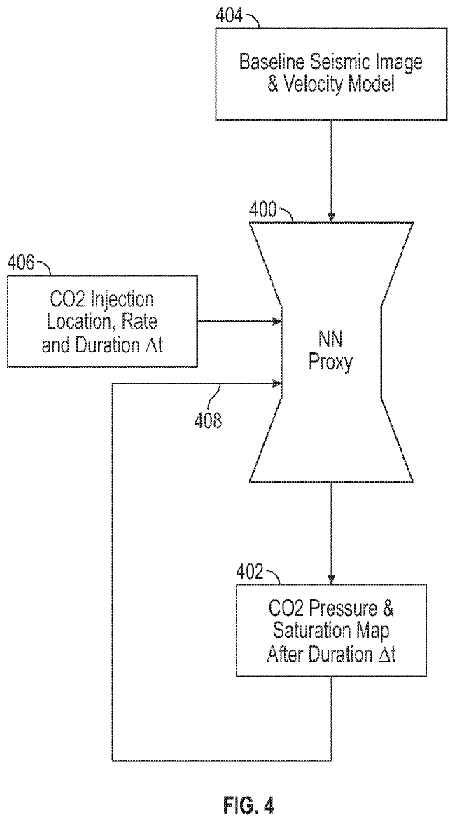

FIG. 4 illustrates a schematic view of a basic unit of a reservoir proxy model 400, according to an embodiment. The reservoir proxy model 400 may be a machine learning model, for example, a convolutional neural network. Further, the model 400 may be a recurrent network.

The reservoir proxy model 400 may be configured to receive multiple channels of input and produce a prediction 402 of a feature of a subsurface volume, for example, a map representing a CO2 plume body in the subsurface volume, which may change over time while CO2 injection operations are on-going. In particular, the model 400 may receive a first input 404, which may be a baseline seismic image and a velocity model 404 of the subsurface volume, e.g., prior to the initiation of CO2 injection operations. The model 400 may also include a second input 406, which may represent injection data, such as CO2 injection location, rate, and duration (e.g., a timestep Δt) that elapsed during the injection operation. The model 400 may also receive, as a third input 408, a CO2 pressure and saturation map representing the subsurface volume at the end of the prior timestep Δt.

Thus, the output 402 provides one of the inputs 408. More particularly, for a given timestep Δtₙ, the output 402 from the model 400's prediction for the prior timestep Δtₙ₋₁ may be used as the input 408 to the model 400. In the case of the first timestep Δt₁, any suitable value for the initial CO2 pressure and saturation map may be used, e.g., null, zero, or any other arbitrary or calculated value. As can be appreciated, the model 400 may not rely on seismic data acquired during a given timestep Δtₙ, but may make predictions based on earlier (baseline) seismic data, taken prior to the initiation of injection operations, injection data observed during the timestep Δtₙ, and the output generated for a prior timestep Δtₙ₋₁.

### Training the Proxy Model Using Interpreter-Derived Plume Body as Ground Truth Label

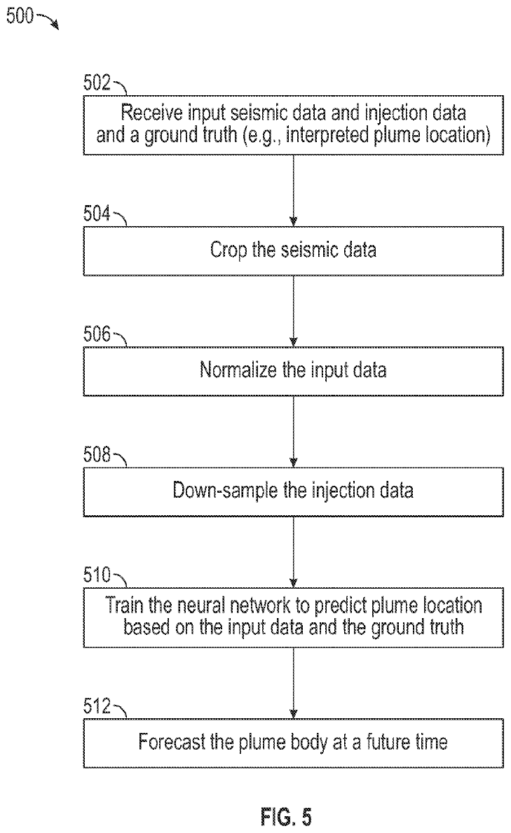

FIG. 5 illustrates a flowchart of a method 500 for training a model to predict a feature of a subsurface volume, e.g., a plume body location, using an interpreter-derived plume body as a ground-truth label, according to an embodiment. The method 500 includes receiving input, as at 502. In this embodiment, several different types of input may be obtained. The first inputs may be or include seismic images or subsurface property profiles obtained from the baseline seismic data through seismic processing procedures. Another input may include historical injection rates and injector locations. Additionally, interpreter-derived plume body geometry may be received as a ground-truth as part of the input.

The method 500 may then include cropping seismic data to an identified target volume, as at 504. Seismic image volumes and/or other subsurface property volumes (e.g., velocity model, interpreted plume body) generated from seismic data, including both baseline and monitor data, are typically larger than the reservoir volume. Cropping all the seismic image volumes and/or other subsurface property volumes to fit the target volume of interest may speed up the implementation of the method 500, e.g., without consuming additional computing resources.

The method 500 may further include normalizing the input data for the identified target volume, as at 506. The dynamic ranges of the seismic and/or property data may not be suitable for the neural network operation. Normalization of the input data is thus provided, e.g., for data with large dynamic ranges. In this context, normalization may refer to setting values between −1 and 1, or between 0 and 1, or between another two suitable end points for a uniform range.

The method 500 may also include down-sampling the injection data received as input, as at 508. For example, the frequency at which CO2 injection data is acquired may be much higher than the frequency at which the seismic monitoring data is acquired. Thus, the CO2 injection data resolution may be reduced to more closely match that of the seismic monitoring data. More particularly, for example, the time lapse between successive CO2 injection data points may be much smaller than between successive shot gathers for seismic data acquisition. Thus, if the frequency of CO2 injection is higher than seismic monitoring acquisition, down-sampling of the injection data can reduce the number of time steps to enhance computing efficiency. In other words, an example of down sampling may include obtaining a lower resolution injection rate from a higher resolution through an averaging operation. More specifically, continuing with this example, a given daily injection rate may be down-sampled to obtain average monthly injection rate.

The method 500 may further include training a machine learning model, e.g., a neural network, using the (e.g., cropped and down-sampled) input data, as at 510. The baseline seismic image and/or velocity model, along with the injection rate/location and the time duration of the current time step, and the pressure and saturation maps from the previous time step are input into the model. A cutoff threshold may be applied to the output of the network to obtain a CO2 plume body contour. The mean square error of the difference between the network output contour and the interpreter-derived CO2 plume body contour can be used as the loss function. Training of the network may be conducted to reduce/minimize the loss function. Training may be stopped until a certain loss value or a certain number of epochs is reached.

The method 500 may further include forecasting the plume body through network inferencing, as at 512. In some embodiments, without acquiring additional seismic data, the trained network may be used to forecast the CO2 pressure and saturation maps and/or plume body geometry for any future year with the provided information of CO2 injection location, injection rate, time duration, and the pressure and saturation maps from the previous time step.

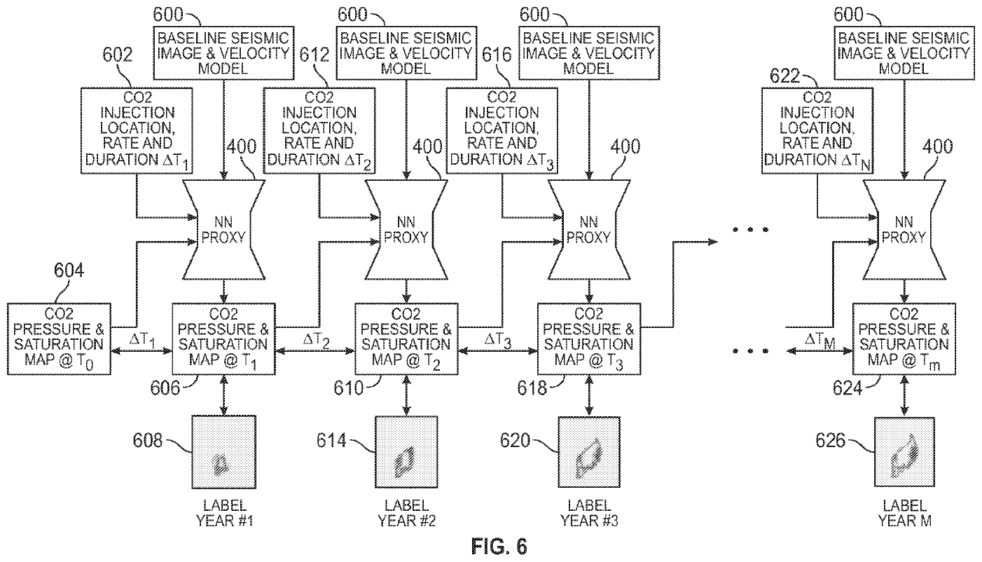

FIG. 6 illustrates a schematic view of the model 400 executing the method 500 of FIG. 5 for multiple timesteps, according to an embodiment. In particular, the model 400 is shown executing multiple predictions, e.g., for successive timesteps, Δt₁, Δt₂, Δt₃, . . . , Δtₙ, so as to iteratively train the model 400. For example, in a first timestep Δt₁, the model 400 may receive a baseline seismic image and velocity model 600, CO2 injection information 602 (e.g., CO2 injection location, rate, and duration of the timestep Δt₁), and an initial information 604 (e.g., CO2 pressure and saturation map prior to the first timestep, e.g., at time tₒ). The model 400 may receive these inputs 600, 602, 604 and generate a prediction 606, e.g., a CO2 pressure and saturation map 606 for the conclusion of the timestep Δt₁, e.g., at time t₁.

The prediction 606 may then be compared with a ground-truth 608, such as a human-interpolated CO2 pressure and saturation map, based on the same inputs 600-604, but generated at least partially by a human. The differences between the ground-truth 608 and the prediction 606 may be used to modify/train the model 400.

This process may repeat for a second timestep Δt₂, as shown, generating a second output 610, a prediction at the conclusion of the second timestep Δt₂ that may be compared to a second ground-truth 612. In the prediction of the second timestep Δt₂, the initial injection information 602 may be replaced by the output 606 of the model 400 from the prior timestep Δt₁. This may then be repeated to train the model 400 at each successive timestep Δtₙ, using the output from a prior timestep for the next timestep, and at each iteration, comparing the output generated to a ground-truth (e.g., a CO2 pressure and saturation map at the same chronological time as the prediction/output) in order to train the model 400. Accordingly, it will be appreciated that the model 400 may be adjusted one or more times at each timestep to match the ground-truth at this time step, thereby history-matching the model 400.

Training the Proxy Model Using the Monitoring Seismic Data and/or its Derived Property Data as Ground Truth Label

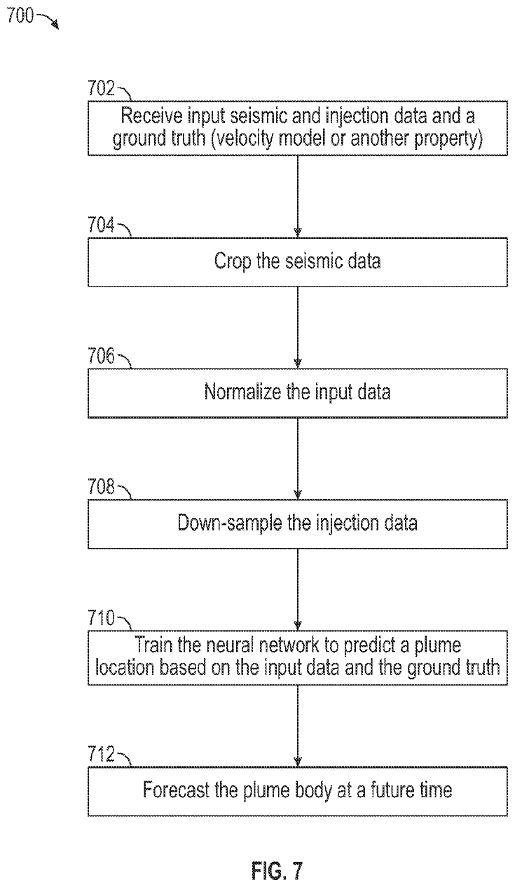

FIG. 7 illustrates a flowchart of another method 700 for training a model to predict a feature of a subsurface volume, e.g., a plume body location, according to an embodiment. In this embodiment, the method 700 may include receiving input data, as at 702. The input data may include seismic images or subsurface property profiles obtained from the baseline seismic data and the monitoring data through seismic processing procedures. The input data may also include seismic images, velocity profiles, or another subsurface property model. The input data may also include historical injection rates and injector locations. In contrast to the method 500, the input received at 702 in the method 700 may not include interpreter-identified plume body locations as ground-truth data.

The method 700 may then include cropping the input seismic data to the target volume, as at 704. The seismic image volumes and/or other subsurface property volumes (e.g., velocity model), including both baseline and monitor data may be larger than the reservoir volume. Cropping the seismic image volumes and/or other subsurface property volumes to fit the target volume of interest may increase the efficiency of the execution of the method 700 by avoiding calculations for non-targeted volumes.

The method 700 may also include normalizing the input data, as at 706. The dynamic range of seismic and/or property data may not be suitable for the neural network operation. Normalization of the input data is thus employed, e.g., for data sets with large dynamic ranges, e.g., setting the ranges to −1 to 1, or 0 to 1, or any other selected range, across data sets.

The method 700 may also include down sampling the input injection data, as at 708. As discussed above, if the frequency of CO2 injection data collection is higher than seismic monitoring acquisition, down-sampling of the injection data can reduce the number of time steps to enhance computing efficiency.

The method 700 may also include training a machine learning model, e.g., a neural network, based on the input data, as at 710. The baseline seismic image and/or velocity model, along with the injection rate/location and the time duration of the current timestep, and the pressure and saturation maps from the previous timestep are input into the model. In this case, the ground-truth label may not be directly utilized through a thresholding operator to construct a loss function, because the label and proxy output belong to different data categories, e.g., other reservoir/formation attributes.

Accordingly, one or more convolution layers (e.g., another machine learning model) can be applied to the ground-truth label to obtain a latent layer. Then the mean square error, or any other measure, of the difference between the latent layer and proxy output can be used as the loss function. To enhance the capability of the convolution layers for plume body feature identification and characterization from the provided label (seismic image, velocity model, or other subsurface properties), input to the convolution layers may include both the baseline data and the monitor data. Training of the network is conducted to reduce/minimize the loss function. Training may be stopped when a certain loss value or a certain number of epochs is reached.

The method 700 may further include forecasting the plume body location through network inferencing, as at 712. Without acquiring any additional seismic data, in at least some embodiments, the trained network may be used to forecast the CO2 pressure and saturation maps and/or plume body geometry for any future year with the provided information of CO2 injection location, injection rate, time duration, and the pressure and saturation maps from the previous time step.

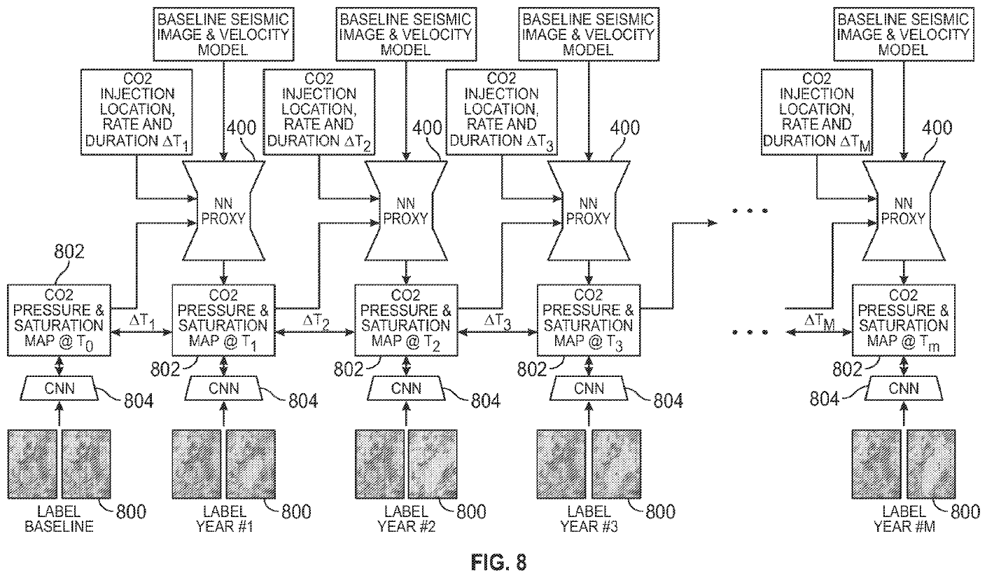

FIG. 8 illustrates a schematic view of the model 400 executing the method 700 of FIG. 7, according to an embodiment. As with the model 400 executing the method 500 of FIG. 5, the process may iterative across multiple timesteps Δt₁, Δt₂, . . . , Δtₙ, with the model 400 be repeatedly used to forecast, and then trained against ground-truths 800. However, in this case, ground-truths 800 (observations, measurements, etc.) may not be the same type of data as the outputs 802 the model 400 is configured to generate; that is, the ground-truths 800 may be something other than CO2 pressure and location maps, such as formation properties, reservoir properties, other measurements, etc. Accordingly, one or more convolutional neural network layers 804 (which may be a second machine learning model) are used, which are trained to generate data of the same category as the outputs 802 of the model 400, to train the model 400 based on the differences between the outputs 802 from the model 400 and the latent/hidden outputs of the layers 804.

### Forecast Plume Body Location

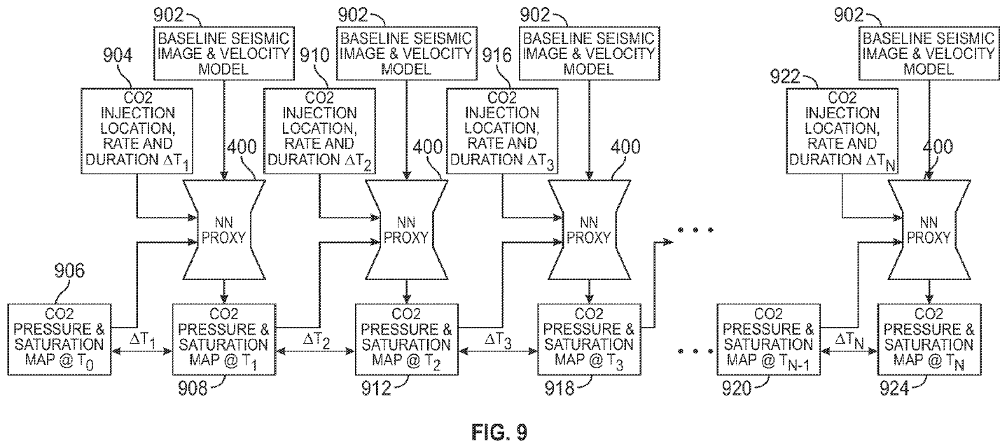

FIG. 9 conceptually illustrates the machine learning model 400 being used to predict a feature of a subterranean volume, e.g., forecasting the plume body, once the model 400 has been trained, according to an embodiment. As with the training phase, the implementation phase illustrated may produce forecasts for CO2 pressure and saturation maps for the subsurface volume of interest at the conclusion of discrete timesteps Δt₁, Δt₂, . . . , Δtₙ. As shown, beginning with the first timestep Δt₁, the machine learning model 400 may be fed input in the form of baseline data 902, e.g., seismic image(s) and/or a velocity model representing the subsurface domain prior to an injection operation. The model 400 may also receive input in the form of injection data 904, e.g., CO2 injection location, rate, and duration of the timestep Δt₁. The model 400 may also receive CO2 pressure and saturation map 906 at a starting time tₒ, which may be set to an initial value (e.g., 0) in the first timestep Δt₁.

The model 400 may employ these inputs 902, 904, 906 to generate an output 908, e.g., a CO2 pressure and saturation map, which is a prediction of the subsurface domain at the end of the first timestep Δt₁, e.g., time t₁. The output 908 may then serve as input for the model 400 in the analysis of the second timestep Δt₂, along with the baseline data 902 and injection data 910 representing the injection process during the second timestep Δt₂. The model 400 may then generate an output 912 based on these inputs 902, 908, 910, which is the CO2 pressure and saturation map at time t₂, the end of the second timestep Δt₂. The output 912 may be employed as input for the third timestep's analysis using the model 400, along with the baseline data 902 and injection data 916 for the third timestep Δt₃, resulting in the model 400 generating an output 918. The sequence may continue with an output 920 from a prior timestep's prediction serving as a channel of input for a subsequent timesteps' analysis, along with the baseline data 902 and the injection data 922 for the individual timestep, which the model 400 may employ to generate an output 924

A visual depiction of the plume body in a subsurface volume may be generated and visualized using a computerized or digital display. In some cases, a human user may interpret the displayed plume body location that is predicted in the future and make field or injection management decisions based thereon, e.g., adjusting one or more wellsite injection operations, equipment parameters/settings, etc.

Accordingly, it is seen that the model 400 may not receive additional seismic data after the model 400 is trained, i.e., during the implementation phase. Rather, the model 400 makes its predictions based on CO2 injection operation inputs, prior predictions, and baseline seismic data.

### Computing Environment

In one or more embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

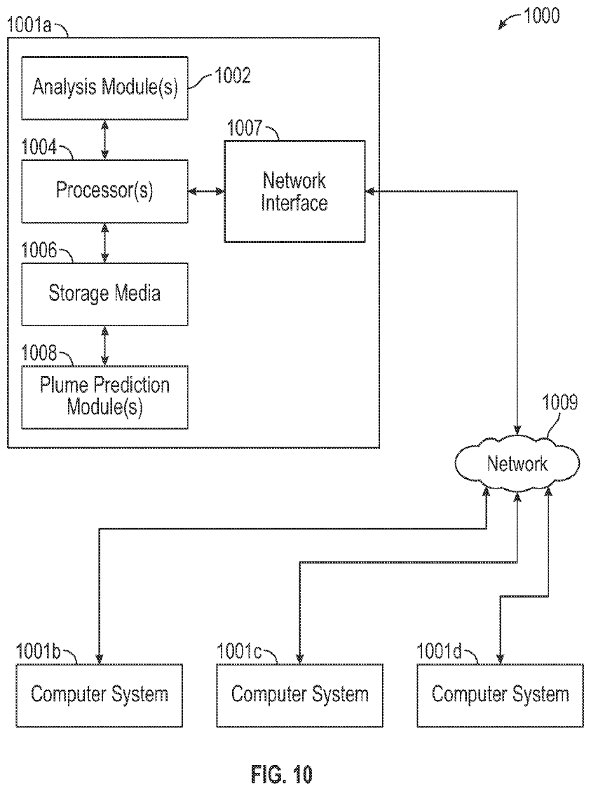

In some embodiments, any of the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis module(s) 1002 configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1000 contains one or more plume prediction module(s) 1008. In the example of computing system 1000, computer system 1001A includes the plume prediction module 1008. In some embodiments, a single plume prediction module may be used to perform some or all aspects of one or more embodiments of the methods. In alternate embodiments, a plurality of plume prediction modules may be used to perform some or all aspects of methods.

It should be appreciated that computing system 1000 is only one example of a computing system, and that computing system 1000 may have more or fewer components than shown, may combine additional components not depicted in the example embodiment of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
receiving input comprising baseline data representing a subsurface volume prior to an injection operation, injection data representing an injection operation during a first timestep, and an initial pressure and saturation data at the beginning of the first timestep;
training a machine learning model to predict a first pressure and saturation map at an end of the first timestep based at least in part on baseline data, the injection data, and the initial pressure and saturation data; and
training the machine learning model to predict a second pressure and saturation model at an end of a second timestep based at least in part on the baseline data, injection data representing the injection operation during the second timestep, and the first pressure and saturation map at the end of the first timestep,
wherein the machine learning model is trained to predict an implementation pressure and saturation map at a plurality of times during an injection operation.

2. The method of claim 1, wherein training the machine learning model comprises history matching predictions from the machine learning model at successive timesteps with observations of corresponding timesteps.

3. The method of claim 1, wherein the input further comprises a ground-truth label of a feature of the subsurface volume at the end of the first timestep that is derived from seismic data representing the subsurface volume, and wherein training the machine learning model comprises comparing the ground-truth label to the predicted first pressure and saturation map.

4. The method of claim 3, wherein the baseline data includes a baseline seismic image and velocity model representing the subsurface volume prior to the injection operation.

5. The method of claim 1, further comprising predicting a ground-truth pressure and saturation map based on a ground truth label using a second machine learning model, wherein training the machine learning model comprises comparing the ground-truth pressure and saturation map to the first pressure and saturation map.

6. The method of claim 1, further comprising:
predicting the implementation pressure and saturation map representing the subsurface volume at one or more times during the injection operation, using the trained machine learning model, wherein predicting does not include collecting additional seismic data after the machine learning model is trained.

7. The method of claim 6, further comprising displaying a visualization of the implementation pressure and saturation map, to permit a human user to manage or make a decision about the injection operation.

8. The method of claim 6, further comprising adjusting one or more wellsite equipment operations based at least in part on the implementation pressure and saturation map.

9. A computing system, comprising:
one or more processors; and
a memory system comprising one or more non-transitory, computer-readable media storing instructions that, when executed by at least one of the one or more processors, cause the computing system to perform operations, the operations comprising:
receiving input comprising baseline data representing a subsurface volume prior to an injection operation, injection data representing an injection operation during a first timestep, and an initial pressure and saturation data at the beginning of the first timestep;
training a machine learning model to predict a first pressure and saturation map at an end of the first timestep based at least in part on baseline data, the injection data, and the initial pressure and saturation data; and
training the machine learning model to predict a second pressure and saturation model at an end of a second timestep based at least in part on the baseline data, injection data representing the injection operation during the second timestep, and the first pressure and saturation map at the end of the first timestep,
wherein the machine learning model is trained to predict an implementation pressure and saturation map at a plurality of times during an injection operation.

10. The computing system of claim 9, wherein training the machine learning model comprises history matching predictions from the machine learning model at successive timesteps with observations of corresponding timesteps.

11. The computing system of claim 9, wherein the input further comprises a ground-truth label of a feature of the subsurface volume at the end of the first timestep that is derived from seismic data representing the subsurface volume, and wherein training the machine learning model comprises comparing the ground-truth label to the predicted first pressure and saturation map.

12. The computing system of claim 11, wherein the baseline data includes a baseline seismic image and velocity model representing the subsurface volume prior to the injection operation.

13. The computing system of claim 9, further comprising predicting a ground-truth pressure and saturation map based on a ground truth label using a second machine learning model, wherein training the machine learning model comprises comparing the ground-truth pressure and saturation map to the first pressure and saturation map.

14. The computing system of claim 9, further comprising:
predicting an implementation pressure and saturation map representing the subsurface volume at one or more times during an injection operation, using the trained machine learning model, wherein predicting does not include collecting additional seismic data after the machine learning model is trained.

15. The computing system of claim 14, wherein the operations further comprise displaying a visualization of the implementation pressure and saturation map, to permit a human user to manage or make a decision about the injection operation.

16. The computing system of claim 14, wherein the operations further comprise adjusting one or more wellsite equipment operations based at least in part on the implementation pressure and saturation map.

17. A non-transitory, computer-readable medium storing instructions that, when executed by at least one processor of a computing system, cause the computing system to perform operations, the operations comprising:
receiving input comprising baseline data representing a subsurface volume prior to an injection operation, injection data representing an injection operation during a first timestep, and an initial pressure and saturation data at the beginning of the first timestep;
training a machine learning model to predict a first pressure and saturation map at an end of the first timestep based at least in part on baseline data, the injection data, and the initial pressure and saturation data; and
training the machine learning model to predict a second pressure and saturation model at an end of a second timestep based at least in part on the baseline data, injection data representing the injection operation during the second timestep, and the first pressure and saturation map at the end of the first timestep,
wherein the machine learning model is trained to predict an implementation pressure and saturation map at a plurality of times during an injection operation.

18. The medium of claim 17, wherein the input further comprises a ground-truth label of a plume at the end of the first timestep that is derived from seismic data representing the subsurface volume, and wherein training the machine learning model comprises comparing the ground-truth label to the predicted first pressure and saturation map.

19. The medium of claim 17, wherein the baseline data includes a baseline seismic image and velocity model representing the subsurface volume prior to the injection operation.

20. The medium of claim 17, further comprising predicting a ground-truth pressure and saturation map based on a ground truth label using a second machine learning model, wherein training the machine learning model comprises comparing the ground-truth pressure and saturation map to the first pressure and saturation map.
